(19) United States
(12) Patent Application Publication
(10) Pub. No.: US 2024/0091685 A1
(43) Pub. Date: Mar. 21, 2024

(54) SYSTEM AND METHOD FOR FILTERING A FLUID

(71) Applicants: Harkirat Sahni, Tampa, FL (US); Andrew Reinhard Krause, Louisville, KY (US); Robert Lee Lewis, JR., Louisville, KY (US)

(72) Inventors: Harkirat Sahni, Tampa, FL (US); Andrew Reinhard Krause, Louisville, KY (US); Robert Lee Lewis, JR., Louisville, KY (US)

(21) Appl. No.: 17/933,931

(22) Filed: Sep. 21, 2022

(51) Int. Cl. B01D 35/143; B01D 35/147; B01D 35/157; B01D 37/04

(52) U.S. Cl. CPC B01D 35/143; B01D 35/147; B01D 35/1573; B01D 37/04; B01D 2201/08; B01D 2201/52; B01D 2201/56

(57) ABSTRACT

A system and method for filtering a fluid includes a manifold and a filter releasably connected to the manifold that includes a memory storage device. A filter valve in fluid communication with the manifold has an open position that allows the fluid to flow through the filter and a shut position that prevents the fluid from flowing through the filter valve. A sensor in fluid communication with the manifold generates a fluid parameter signal reflective of a characteristic of the fluid flowing through the manifold. A controller receives the fluid parameter signal and positions the filter valve to the shut position when the fluid parameter signal meets a predetermined fluid condition.

### FIELD OF THE INVENTION

The present invention generally involves a system and method for filtering a fluid. In particular embodiments, the system and method may be incorporated into or upstream from private or commercial appliances and other fluid consumption points.

### BACKGROUND OF THE INVENTION

Many fluid (e.g., water) filter systems exist and generally include a manifold associated with a changeable filter. The filter generally includes a filter medium enclosed in a filter housing that is removably associated with the manifold. The manifold directs water to and through the filter so that filtered water exits the filter system. The filter medium naturally degrades over time and requires replacement. In addition, the filter may be subjected to environmental conditions that may damage the filter medium and cause premature failure. Accordingly, a system and method for filtering a liquid while monitoring the filter's status are needed.

Current fluid filtering systems may associate sensors with the filter but have a limited ability to monitor the filter's status while in use, determine the filter's remaining life, and document the environmental history of the filter in a way that aids in determining the cause of a premature filter failure. Therefore, a need exists for a cost-effective way to monitor a filter's status while in use while documenting the environmental history of the filer in a way that aids in determining the cause of a premature filter failure.

### BRIEF DESCRIPTION OF THE INVENTION

Aspects and advantages of the invention are set forth below in the following description, or may be obvious from the description, or may be learned through practice of the invention.

One embodiment of the present invention is a system for filtering a fluid that includes a manifold and a filter releasably connected to the manifold that includes a memory storage device. A filter valve in fluid communication with the manifold has an open position that allows the fluid to flow through the filter and a shut position that prevents the fluid from flowing through the filter valve. A sensor in fluid communication with the manifold generates a fluid parameter signal reflective of a characteristic of the fluid flowing through the manifold. A controller receives the fluid parameter signal and positions the filter valve to the shut position when the fluid parameter signal meets a predetermined fluid condition.

An alternate embodiment of the present invention is a system for filtering a fluid that includes a manifold and a filter releasably connected to the manifold. The filter includes a memory storage device, and identification data is stored in the memory storage device. A filter valve in fluid communication with the filter has an open position that allows the fluid to flow through the filter and a shut position that prevents the fluid from flowing through the filter valve. A controller in communication with the memory storage device positions the filter valve to the shut position when the identification data meets a predetermined identification condition.

In yet another embodiment of the present invention, a method for filtering a fluid includes flowing the fluid through a manifold, a filter releasably connected to the manifold, and a filter valve in fluid communication with the filter that has a shut position that prevents fluid flow through the filter valve. The method further includes storing parameter data in a memory storage device associated with the filter, sensing a parameter of the fluid, and generating a fluid parameter signal reflective of the sensed parameter of the fluid. In addition, the method includes positioning the filter valve to the shut position when the fluid parameter signal meets a predetermined fluid condition.

Upon review of the specification, those of ordinary skill in the art will better appreciate the features and aspects of such embodiments and others.

### BRIEF DESCRIPTION OF THE DRAWINGS

A complete and enabling disclosure of the present invention, including the best mode thereof to one skilled in the art, is set forth more particularly in the remainder of the specification, including reference to the accompanying figures, in which:

FIG. 1 is a block diagram of a system for filtering a fluid according to one embodiment of the present invention;

FIG. 2 is a block diagram of electrical features of an exemplary system for filtering a fluid; and

FIG. 3 is a flow diagram of an algorithm for the system logic according to one embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used in the claims, the definite article “said” identifies required elements that define the scope of embodiments of the claimed invention. In contrast, the definite article “the” merely identifies environmental elements that provide context for embodiments of the claimed invention that are not intended to be a limitation of any claim.

As used herein, the term “fluid communication” refers to a fluid pathway, and components are in fluid communication with each other if a fluid pathway exists between the components. As used herein, the terms “upstream” and “downstream” refer to the location of items with reference to the direction of fluid flow in a fluid pathway. For example, item A is “upstream” from item B, and item B is downstream from item A if fluid normally flows from item A to item B. As used herein, “in parallel” means that two components are in fluid communication with a third component such that the fluid may flow in the same direction through separate streams through either component.

Embodiments of the present invention include a system and method for a fluid filter system configured to supply a filtered fluid to a dispense point. The system and method may be operated as a standalone device or integrated into or incorporated upstream or downstream from an appliance or a plurality of appliances in either a commercial or non-commercial environment. In particular embodiments, the system and method uniquely identify a filter, monitor the filter's environmental parameters, and associate parameter data with the filter.

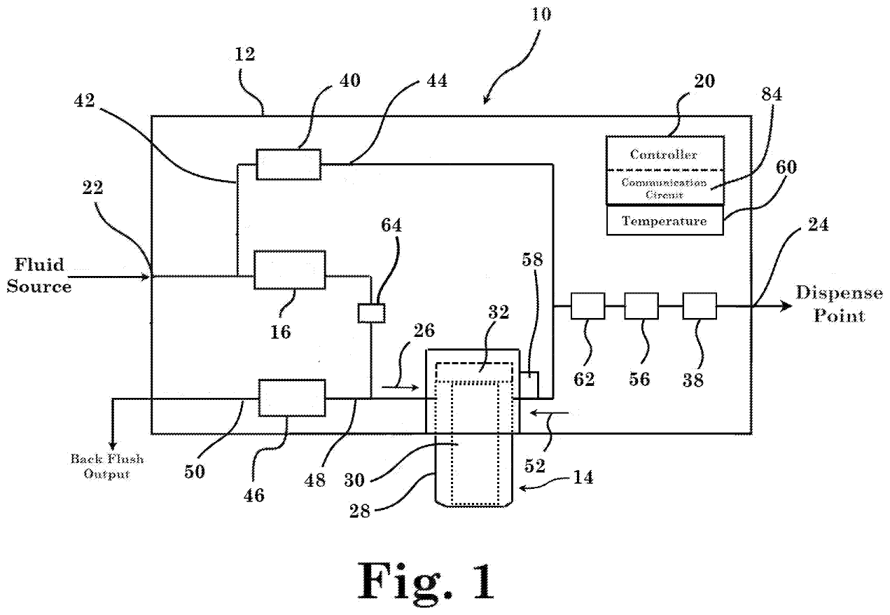

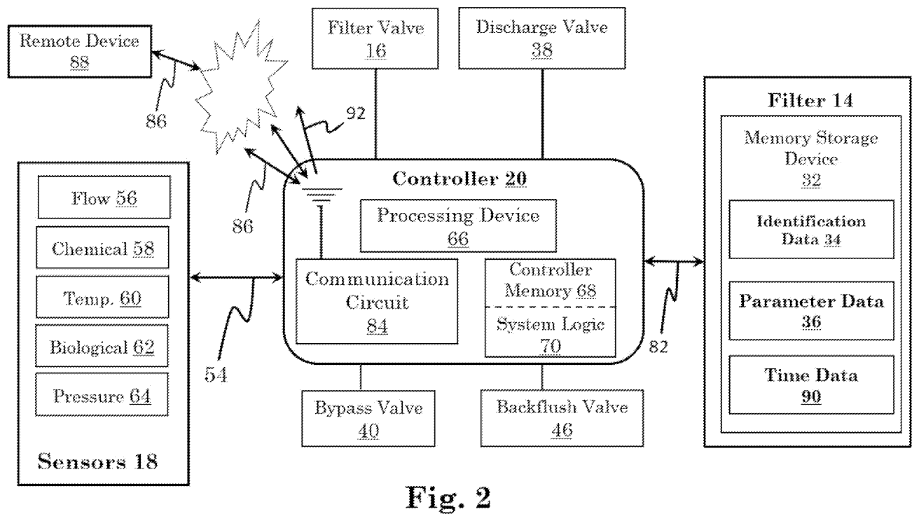

FIG. 1 provides a block diagram of a system 10 for filtering a fluid according to one embodiment of the present invention, and FIG. 2 provides a block diagram of electrical features of an exemplary system for filtering a fluid. As shown in FIGS. 1 and 2, the system 10 generally includes a manifold 12, a filter 14, a filter valve 16, one or more sensors (referred to collectively as sensors 18 in FIG. 2), and a controller 20.

The manifold 12 may have a manifold input 22 in fluid communication with a manifold output 24. The manifold 12 may be a monolithic component and/or a combination of piping, tubing, or similar structures for conveying fluid and may be constructed from any suitable materials such as metal (e.g., aluminum, brass, bronze, cast iron, ductile iron, copper, steel, stainless steel), non-metal (e.g., acetal polymers, polyvinyl chloride PVC, chlorinated PVC, Polytetrafluoroethylene PTFE, polyethylene PE, polypropylene PP, Polyvinylidene fluoride PVDF), and composite materials (e.g., fiber-reinforced plastics, glass reinforced plastics, high-density polyethylene).

The filter 14 is releasably connected to the manifold 12, and the manifold 12 provides fluid communication from the manifold input 22 to the filter 14 and from the filter 14 to the manifold output 24, thereby defining a normal flow direction 26 through the filter 14. The filter 14 may be any suitable filter for filtering the fluid and generally includes a filter housing 28 with a filter medium 30 positioned inside the filter housing 28. The filter medium 30 may be a physical barrier that removes suspended solids from the fluid flowing through the filter 14. Alternatively, the filter medium 30 may include ultraviolet light or similar technologies for purifying the fluid flowing through the filter 14. The filter 14 may alter the fluid in some way that may affect smell, hue, turbidity, chemical contaminant levels, microbial contaminant levels, and/or taste. The filter 14 may adjust the chemistry of the fluid, such as pH, salinity, chloride, fluoride, mercury, lead, nitrates, and bromate levels in the fluid, to name a few. The filtering technologies may include sediment, pleated sediment, carbon block, and granular activated carbon technologies. Ultraviolet light technologies may also be used for the filtering of microorganisms. Exemplary filter types include mechanical, absorption, reverse osmosis, nanofiltration, and sequestration filters.

As depicted in FIG. 1, the filter 14 may include a memory storage device 32. The memory storage device 32 may be any suitable device that can store information to be accessed when needed for processing. Suitable memory technologies include ROM, RAM, and EPROM memory types. In particular embodiments, the memory storage device 32 may be in communication with the controller 20 when the filter 14 is properly mechanically associated with the manifold 12. The memory storage device 32 may store identification data 34 and/or parameter data 36. Identification data 34 is any data that uniquely identifies the filter 14, such as a serial number, or more generally identifies filter 14, such as a model number or batch number. Parameter data 36 is data that describes or reflects a filter parameter or data that may be used to determine a filter parameter. For example, parameter data 36 may be a filter's estimated remaining life value, a damaged filter flag, an incorrect filter type flag, a maximum measured pressure value, or similar data types. Parameter data 36 may include flag values (1, 0, G, B, Good, Bad, etc.) or threshold values that may be a filter limit such as a pressure limit or temperature limit.

The filter valve 16 is in fluid communication with the manifold 12 and has an open position that allows the fluid to flow through the filter 14 and a shut position that prevents the fluid from flowing through the filter valve 16. The filter valve 16 may be biased to the open position as a default position for some embodiments. The filter valve 16 may be located upstream from the filter 14 as shown in FIG. 1, or alternatively, the filter valve 16 may be located downstream from the filter 14.

In particular embodiments, the system 10 may further include a discharge valve 38 in fluid communication with the manifold 12 downstream from the filter 14 and upstream from the manifold output 24. The discharge valve 38 may have a shut position that prevents fluid from flowing out of the manifold 12 and an open position that allows fluid to flow out of the manifold 12. The discharge valve 38 may be biased to the open position as a default position.

In other particular embodiments, the system 10 may include a bypass valve 40 in fluid communication with the manifold 12 and in parallel with the filter 14. As shown in FIG. 1 for example, the bypass valve 40 may have a bypass valve input 42 upstream from the filter valve 16 and the filter 14 and a bypass valve output 44 downstream from the filter 14 during fluid flow in the normal flow direction 26. In this manner, the bypass valve 40 may have an open position that allows the fluid to flow around the filter 14 and a shut position that prevents the fluid from flowing through the bypass valve 40. The bypass valve 40 may be biased to the shut position as a default position.

For another alternative embodiment, the system 10 may include a backflush valve 46 in fluid communication with the manifold 12 and having an open position that allows the fluid to flow out of the manifold 12. The backflush valve 46 may have a backflush valve input 48 downstream from the filter valve 16 and upstream from the filter 14 during fluid flow in the normal flow direction 26, and a backflush valve output 50 that directs the fluid out of the manifold 12 when the fluid is flowing through the filter 14 in a reverse flow direction 52 relative to the normal flow direction 26.

The table below indicates exemplary open and shut states for the various system 10 valves.

| | Filter | Discharge | Bypass | Backflush |
|---|---|---|---|---|
| | Valve | Valve | Valve | Valve |
| Description | 16 | 38 | 40 | 46 |
| Default | Open | Open | Shut | Shut |
| Provides filtered fluid to a | Open | Open | Shut | Shut |
| dispense point | | | | |
| Bypasses Filter 14 and | Shut | Open | Open | Shut |
| Provides unfiltered fluid to | | | | |
| a dispense point | | | | |
| Provides reverse flow through | Shut | Shut | Open | Open |
| the filter 14 | | | | |
| Disabled Fluid Filter System | Shut | Shut | Shut | Shut |

Any suitable remotely actuated valves may be used, including electric motor operated valves, pneumatic operated valves, and hydraulic operated valves. Exemplary valves include bistable solenoid valves or normally closed solenoid valves.

Referring now to FIGS. 1 and 2, the one or more sensors 18 are in fluid communication with the manifold 12 to generate a fluid parameter signal 54 reflective of a characteristic of the fluid flowing through the manifold 12. Each sensor 18 may communicate the fluid parameter signal 54 to the memory storage device 32 where it may be stored as parameter data 36. Alternately or in addition, each sensor 18 may communicate the fluid parameter signal 54 to the controller 20.

The one or more sensors 18 may be any suitable sensor for measuring a characteristic of the fluid flowing through the manifold 12, such as instantaneous flow rate, cumulative flow, pressure, temperature, pH, and/or contaminant level of the fluid flowing through the manifold 12. For example, a flow sensor 56 may generate the fluid parameter signal 54 reflective of the instantaneous flow rate or cumulative flow of the fluid through the manifold 12. A chemical sensor 58 may generate the fluid parameter signal 54 reflective of the pH, salinity, Chloride, Fluoride, Mercury, Lead, or other chemical level in the fluid flowing through the manifold 12. A temperature sensor 60 may generate the fluid parameter signal 54 reflective of the temperature of the fluid flowing through the manifold 12. A biological sensor 62 may generate the fluid parameter signal 54 reflective of the biological contaminant level, such as bacteria, present in the fluid flowing through the manifold 12. A pressure sensor 64 may generate the fluid parameter signal 54 reflective of the pressure of the fluid flowing through the manifold 12. One of ordinary skill in the art will readily appreciate additional or alternative sensors that may be included to generate the fluid parameter signal 54, and the present invention is not limited to any particular sensor unless specifically recited in the claims.

The controller 20 may include, for example, a processing device 66 electrically associated with a controller memory 68. The processing device 66 may be an ASIC (application-specific integrated circuit), an ASSP (application-specific standard product), or a PIC (programmable Intelligent Computer). The controller memory 68 may be an on-chip memory associated with the processing device 66 or an off-chip memory. The controller memory 68 may include ROM, RAM, and/or EPROM type memories for storing a system logic 70, the parameter data 36 and/or the identification data 34. In this manner, the processing device 66 may execute or access the system logic 70 to provide the features and services described herein.

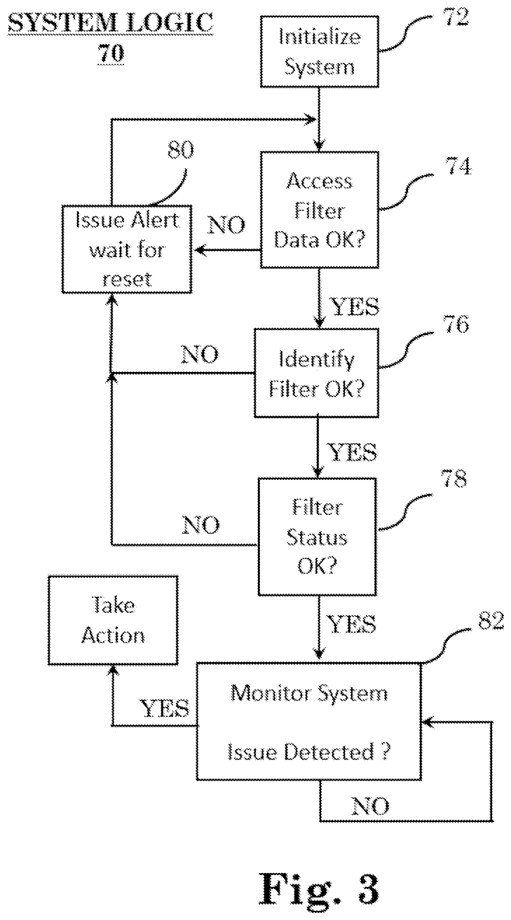

FIG. 3 provides a flow diagram of an algorithm for the system logic 70 according to one embodiment of the present invention. As shown in FIG. 3, the system logic 70 initializes 72 the system 10 by applying power to the system 10 or generating a reset command. At blocks 74, 76, and 78, the system logic 70 causes the controller 20 to access the filter 14 to verify the presence of the correct filter 14 and that the filter status is OK. If the correct filter 14 is not present or OK, the system logic 70 passes to block 80 where the controller 20 may disable the fluid filter system 10, issue an alert for the problem detected, and/or return to block 72 to reset the system 10. A reset may be triggered in any number of ways, including user input, waiting a timeout period, or other suitable methods. If the correct filter is present and OK, control passes to block 82 where the fluid filter system 10 is activated so that the controller 20 monitors the performance of the system 10 and positions one or more the valves 16, 38, 40, 46 to achieve the desired fluid flow through the manifold 12.

As best seen in FIG. 2, for example, the controller 20 may communicate with the sensors 18 and/or the memory storage device 32 to receive the fluid parameter signals 54 generated by the sensors 18 and/or the parameter data 36 stored in the filter 14 and compare the fluid parameter signals 54 and/or parameter data 36 to a predetermined fluid condition. The predetermined fluid condition is an instantaneous or cumulative characteristic of the fluid flowing through the manifold that indicates that the filter 14 may have been exposed to fluid that exceeds the capability of the filter 14 or that the filter 14 has been damaged or depleted and should be removed from operation. For example, the predetermined fluid condition may be a maximum instantaneous flow rate, pH, temperature, pressure, and/or contaminant level of the fluid flow through the manifold 12 that may damage or deplete the filter medium 30. Alternately, the predetermined fluid condition may be a cumulative flow, time at temperature, time at pressure, or contaminant level of the fluid flow through the manifold that indicates the filter medium 30 may be damaged or depleted and should be replaced.

In particular embodiments, the controller 20 may position one or more of the valves 16, 38, 40, 46 to achieve the desired fluid flow through the manifold 12 when the fluid parameter signal 54 meets or exceeds the predetermined fluid condition. For example, the controller 20 may position the filter valve 16 and/or the discharge valve 38 (if present) to the shut position when the fluid parameter signal 54 meets or exceeds the predetermined fluid condition to prevent additional flow through the filter 14. Alternately or in addition, the controller 20 may position the filter valve 16 to the shut position, the discharge valve 38 to the open position, and the bypass valve 40 to the open position when the fluid parameter signal 54 meets or exceeds the predetermined fluid condition to allow the fluid to continue to flow through the manifold 12 while bypassing the filter 14. In yet another embodiment, the controller 20 may position the filter valve 16 to the shut position, the discharge valve 38 to the shut position, the bypass valve 40 to the open position, and the backflush valve 46 to the open position when the fluid parameter signal 54 meets or exceeds the predetermined fluid condition to allow the fluid to flow through the filter 14 in the reverse flow direction 52 relative to the normal flow direction 26 to backflush the filter medium 30.

In other particular embodiments, the controller 20 may be in communication with the memory storage device 32 to position one or more of the valves 16, 38, 40, 46 when the identification data 34 matches a predetermined identification condition. The predetermined identification condition is a serial number, model number, batch number, or other identifier that indicates a filter that has been used, identified as defective, recalled, or is otherwise not suitable for continued use. Accordingly, the controller 20 may position the filter valve 16 and/or the discharge valve 38 (if present) to the shut position when the identification data 34 matches the predetermined identification condition to prevent additional flow through the filter 14. Alternately or in addition, the controller 20 may position the filter valve 16 to the shut position, the discharge valve 38 to the open position, and the bypass valve 40 to the open position when the identification data 34 matches the predetermined identification condition to allow the fluid to continue to flow through the manifold 12 while bypassing the filter 14.

In alternate embodiments, the system 10 may further include a communication circuit 84 that transmits and/or receives a system signal 86 to and/or from a remote device 88 over a wired or wireless connection. Suitable technologies for the communication circuit 84 may be custom designs as well as WiFi and Bluetooth transceivers, GPRS, GSM, 3G, 4G, 5G and EDGE enabled networks and WAP networks. The communication circuit 84 may be compatible with the Internet Of Things (IoT) technologies, and such communications may take the form of SMS and e-mail messages. The remote device 88 may be a smartphone, tablet, laptop, or other computer or storage device a remote user uses. The system signal 86 may include the fluid parameter signal 54, the parameter data 36, the identification data 34, and/or time data 90. The system signal 86 from the remote device 88 may contain a command update message or a data update message. A command update message may be an instruction for the controller 20 to follow, such as disabling the system 10. A data update message may include a firmware update for the controller 20, sensors 18, and/or system logic 70.

As shown in FIG. 2, the controller 20 may further generate a filter status signal 92 reflective of a condition of the filter 14 and may communicate the filter status signal 92 to the remote device 88 and/or the memory storage device 32. The filter status signal 92 provides information about the operational status of the filter 14. For example, the filter status signal 92 may be a flag such as an incorrect filter type flag, a damaged filter flag, a used filter flag, etc. The filter status signal 92 may also include data values that indicate the life remaining for the filter 14 or a high temperature value, a low temperature value, a maximum flow rate value, an average flow rate value, etc.

The system 10 described and illustrated in FIGS. 1-3 may also provide a method for filtering the fluid. In one embodiment, the method for filtering the fluid includes flowing the fluid through the manifold 12, the filter 14 releasably connected to the manifold 12, and the filter valve 16 in fluid communication with the filter 14 and storing the parameter data 36 in the memory storage device 32 associated with the filter 14. The method further includes sensing a parameter of the fluid, generating the fluid parameter signal 54 reflective of the sensed parameter of the fluid, and positioning the filter valve 16 to the shut position when the fluid parameter signal 54 meets the predetermined fluid condition. Alternately or in addition, the method for filtering the fluid may include storing the identification data 34 in the memory storage device 32 and positioning the filter valve 16 to the shut position when the identification data 34 matches the predetermined identification condition.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

1. A system for filtering a fluid comprising:
a manifold;
a filter releasably connected to said manifold wherein said filter includes a memory storage device;
identification data stored in said memory storage device, wherein said identification data comprises at least one of a serial number, a model number, or a batch number;
a filter valve in fluid communication with said manifold that has an open position that allows the fluid to flow through said filter and a shut position that prevents the fluid from flowing through said filter valve;
a sensor in fluid communication with said manifold that generates a fluid parameter signal reflective of a characteristic of the fluid flowing through said manifold; and
a controller that receives said fluid parameter signal and positions said filter valve to said shut position when said fluid parameter signal meets a predetermined fluid condition.

2. The system for filtering the fluid as in claim 1, wherein said filter valve is upstream from said filter.

3. The system for filtering the fluid as in claim 1, wherein said controller generates a filter status signal reflective of a condition of said filter and communicates said filter status signal to a remote device.

4. The system for filtering the fluid as in claim 1, wherein said controller communicates said fluid parameter signal to said memory storage device.

5. The system for filtering the fluid as in claim 1, wherein said controller communicates with said memory storage device and receives said identification data from said memory storage device, and said controller positions said filter valve to said shut position when said identification data meets a predetermined identification condition.

6. The system for filtering the fluid as in claim 1, further comprising a discharge valve in fluid communication of said manifold downstream of said filter, wherein said discharge valve has a shut position that prevents fluid from flowing out of said manifold and an open position that allows fluid to flow out of said manifold, and wherein said controller positions said discharge valve to the shut position when said fluid parameter signal meets said predetermined fluid condition.

7. The system for filtering the fluid as in claim 1, further comprising a bypass valve in fluid communication with said manifold in parallel with said filter, wherein said bypass valve has an open position that allows the fluid to flow through said bypass valve, and wherein said controller positions said bypass valve to said open position when said fluid parameter signal meets said predetermined fluid condition.

8. The system for filtering the fluid as in claim 7, further comprising a backflush valve in fluid communication with said manifold that has an open position that allows the fluid to flow out of said manifold, and wherein and said controller positions said backflush valve to said open position when said fluid parameter signal meets said predetermined fluid condition.

9. The system for filtering the fluid as in claim 1, wherein said fluid parameter signal is reflective of at least one of a flow rate or a total flow of the fluid flow through said manifold.

10. The system for filtering the fluid as in claim 1, wherein said fluid parameter signal is reflective of at least one of a temperature, a pH, a pressure, a chemical contaminant level, or a biological contaminant level of the fluid flowing through said manifold.

11. A system for filtering a fluid comprising:
a manifold;
a filter releasably connected to said manifold wherein said filter includes a memory storage device;
identification data stored in said memory storage device, wherein said identification data comprises at least one of a serial number, a model number, or a batch number;
a filter valve in fluid communication with said filter that has an open position that allows the fluid to flow through said filter and a shut position that prevents the fluid from flowing through said filter valve; and
a controller in communication with said memory storage device, wherein said controller positions said filter valve to said shut position when said identification data matches a predetermined identification condition.

12. The system for filtering the fluid as in claim 11, wherein said filter valve is upstream from said filter.

13. The system for filtering the fluid as in claim 11, wherein said controller generates a filter status signal reflective of a condition of said filter and communicates said filter status signal to a remote device.

14. The system for filtering the fluid as in claim 11, wherein said controller is configured to receive a remote signal comprising a command update message or data update message from a remote device.

15. The system for filtering a fluid as in claim 11, further comprising a sensor in fluid communication with said manifold that generates a fluid parameter signal reflective of a characteristic of the fluid flowing through said manifold, and wherein said controller receives said fluid parameter signal and positions said filter valve to said shut position when said fluid parameter signal meets a predetermined fluid condition.

16. The system for filtering the fluid as in claim 15, further comprising a discharge valve in fluid communication of said manifold downstream from said filter, wherein said discharge valve has a shut position that prevents fluid from flowing out of said manifold and an open position that allows fluid to flow out of said manifold, and wherein said controller positions said discharge valve to said shut position when said fluid parameter signal meets said predetermined fluid condition.

17. The system for filtering the fluid as in claim 15, further comprising a bypass valve in fluid communication with said manifold in parallel with said filter, wherein said bypass valve has an open position that allows the fluid to flow through said bypass valve, and wherein said controller positions said bypass valve to said open position when said fluid parameter signal meets said predetermined fluid condition.

18. The system for filtering the fluid as in claim 17, further comprising a backflush valve in fluid communication with said manifold that has an open position that allows the fluid to flow out of said manifold, and wherein and said controller positions said backflush valve to said open position when said fluid parameter signal meets said predetermined fluid condition.

19. A method for filtering a fluid, comprising:
flowing the fluid through a manifold, a filter releasably connected to said manifold, and a filter valve in fluid communication with said filter, wherein said filter valve has a shut position that prevents fluid flow through said filter valve;
storing parameter data and identification data in a memory storage device associated with said filter, wherein said identification data comprises at least one of a serial number, a model number, or a batch number;
sensing a parameter of the fluid;
generating a fluid parameter signal reflective of said sensed parameter of the fluid; and
positioning said filter valve to said shut position when said fluid parameter signal meets a predetermined fluid condition.

20. The method for filtering a fluid as in claim 19, further comprising positioning said filter valve to said shut position when said identification data matches a predetermined identification condition.
